(19) United States
(12) Patent Application Publication
(10) Pub. No.: US 2025/0162528 A1
(43) Pub. Date: May 22, 2025

(54) Intrusion Guard for a Trailer

(71) Applicant: Zephyros, Inc., Romeo, MI (US)

(72) Inventors: Henry E. Richardson, Romeo, MI (US); Joseph R. Thomas, Romeo, MI (US); Garrett Taylor, Romeo, MI (US); Karthik Kandra, Romeo, MI (US)

(21) Appl. No.: 18/839,252

(22) PCT Filed: Jan. 5, 2023
(86) PCT No.: PCT/US2023/060161

§ 371 Date: Aug. 16, 2024

Related U.S. Application Data
(60) Provisional application No. 63/312,434, filed on Feb. 22, 2022.

(51) Int. Cl. B60R 19/56; B60R 19/34

(52) U.S. Cl. CPC B60R 19/56; B60R 19/34

(57) ABSTRACT

An intrusion guard (20) for a trailer (12) of a vehicle ( ) 10, comprising: (a) a reinforcing member (22) adapted for connection to the trailer of the vehicle, wherein the reinforcing member includes a support (28) and an insert (26) positioned at least partially within the support; and (b) a bumper (36) connected to the reinforcing member.

### CROSS-REFERENCE TO RELATED APPLICATIONS

This patent application claims the benefit and priority of U.S. Provisional Application No. 63/312,434, filed on Feb. 22, 2022, all of which is hereby incorporated by reference herein in its entirety for all purposes.

### FIELD

The present invention generally relates to vehicle barrier systems, and more particularly, to composite structures forming an intrusion guard for a vehicle.

### BACKGROUND

Transportation vehicles frequently utilize structural members to form, support, reinforce, or a combination thereof certain vehicle structures. Unfortunately, such members tend to be formed of relatively heavy materials such as metal, adding undesirable weight to the vehicle. For some applications, it has become popular in recent years to employ a composite structure as part of the reinforcement. However, these materials may often still add significant weight and can be costly and time consuming to manufacture. Moreover, the materials used to form the structural members may be structurally deficient when compared to the conventional heavier materials, resulting in a weaker structure unable to withstand a desired load, unable to perform properly, or both. Additionally, it may be difficult to provide sufficient structural support to certain vehicle structures using more lightweight materials, thereby increasing the risk of damage or breakage of the structural members, the vehicle structures being supported by the structural members, or both.

One particular vehicle reinforcement provides an intrusion guard along an underbody of a vehicle. The intrusion guard may be attached to an underrun along a front portion, a rear portion, a side portion, or a combination thereof of a vehicle to prevent an additional vehicle from being compressed beneath the vehicle's underbody during a collision (i.e., to prevent “submarining”). The intrusion guard may provide a crumple zone that gradually stops the additional vehicle before it reaches the clearance gap between the vehicle and the ground. However, intrusion guards may be frequently derived using similar techniques and materials as illustrated above.

Examples of vehicle barrier structures, including but not limited to intrusion guard structures, may be found in U.S. Pat. Nos. 7,284,788; 7,766,403; and 9,623,820; and U.S. patent application Ser. No. 17/598,755; all of which are incorporated herein in their entirety for all purposes. There remains a need for an improved vehicle barrier structure. What is needed is a barrier structure formed using one or more lightweight composite materials. There remains a need for a barrier structure that is lightweight yet provides sufficient structural integrity. What is needed is a barrier structure having one or more lightweight members that provide sufficient structural support during impact. Additionally, there remains a need for a barrier structure that is simple to manufacture and cost effective. What is needed is a barrier structure adapted for implementation into existing vehicle structures without retrofitting or substantial modification to the vehicle structure.

### SUMMARY

The present teachings meet one or more of the present needs by providing an intrusion guard for a trailer of a vehicle, comprising: (a) a reinforcing member adapted for connection to the trailer of the vehicle, wherein the reinforcing member includes a support and an insert positioned at least partially within the support; and (b) a bumper connected to the reinforcing member.

The reinforcing member may be mounted to a sill of the trailer. The intrusion guard may be mounted to the vehicle free of welding or other permanent attachment means that may cause damage to the intrusion guard during removal and/or replacement. The bumper may be free of contact with the trailer. The reinforcing member may be mounted to the sill by a mounting bracket.

Additionally, the support and the insert of the reinforcing members may be different materials. The support and the insert of the reinforcing member may be the same material. The reinforcing member may include interconnecting ribs that form one or more openings along the reinforcing member. The one or more openings may include a cutout, and the insert may be visible through the cutout.

The intrusion guard may include two or more reinforcing members, and preferably four or more reinforcing members. A vertical surface of the reinforcing member may be parallel to a rear face of the trail of the vehicle when the intrusion guard is mounted to the trailer. Similarly, the vertical surface of the reinforcing member may be coplanar with the rear face of the trailer. Furthermore, the bumper may be replaceable.

The reinforcing member may include an outer shell disposed along an outer surface of the support. The outer shell may be steel. The outer shell may be adhered to the support of the reinforcing member by a thermoplastic adhesive overmolded onto the reinforcing member. Moreover, the support, the insert, or both may be a composite material. The reinforcing member may include a fiber-reinforced material. The support may be overmolded around the insert.

Additionally, the reinforcing member may meet Insurance Institute for Highway Safety (THIS) testing protocols for 30% overlap rear impact testing, full rear impact testing, rear angled impact testing, quasi static rear impact testing, or a combination thereof.

The present teachings meet one or more of the present needs by providing an improved vehicle reinforcement structure. The present teachings meet one or more of the present needs by providing: a barrier structure formed using one or more lightweight composite materials; a barrier structure that is lightweight, yet provides sufficient structural integrity; a barrier structure having one or more interlocked members that provide sufficient strength; a barrier structure that is simple to manufacture and cost effective; and a barrier structure adapted for implementation into existing vehicle structures without retrofitting or substantial modification to the vehicle structure.

### DESCRIPTION OF THE DRAWINGS

FIG. 1 is a perspective view of a trailer of a vehicle having a conventional intrusion guard.

FIG. 2 is a perspective view of an intrusion guard in accordance with the present teachings.

FIG. 3 is a side view of the intrusion guard of FIG. 2.

FIG. 4 is a perspective view of a reinforcing member of an intrusion guard in accordance with the present teachings.

FIG. 5 is a graph illustrating the performance of an intrusion guard in accordance with the present teachings during a rear impact test.

FIG. 6 is a graph illustrating the performance of an intrusion guard in accordance with the present teachings during a rear impact test conducted according to CMVSS 223.

FIG. 7 is a graph illustrating the performance of an intrusion guard in accordance with the present teachings during an IIHS Quasi Static rear impact test.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference in their entirety into this written description.

The teachings herein are directed toward a reinforcement structure. The reinforcement structure may function to reinforce a vehicle. The reinforcement structure may function as a barrier to prevent unwanted objects or additional vehicles from being trapped beneath the vehicle. The reinforcement structure may be positioned along an underbody or underrun of a vehicle. The reinforcement structure may be secured to one or more additional structures of the vehicle. For example, the reinforcement structure may be secured to the chassis of a vehicle. The reinforcement structure may be positioned within a clearance gap of a vehicle. The clearance gap may be defined as a distance between the underbody of the vehicle and the ground in which the vehicle is supported by.

The reinforcement structure may be any desired size and shape. For example, the reinforcement structure may have a length substantially similar to a width or length of a front, rear, side, or a combination thereof of a vehicle. The reinforcement structure may have any desired height. The height may be selected to decrease the clearance gap of the vehicle. The height may be selected based on the vehicle being reinforced. The reinforcement structure may be made of one or more materials. The reinforcement structure may have one or more components. The reinforcement structure may be monolithically formed. The reinforcement structure may be configured to increase structural integrity. For example, the reinforcement structure may be configured to compress or crumple a desired amount. The reinforcement structure may crumple about 25 mm or more, about 50 mm or more, or about 75 mm or more. The reinforcement structure may crumple about 150 mm or less, about 125 mm or less, or about 100 mm or less. The crumple zone of the reinforcement structure may decrease penetration of one or more additional vehicles beneath the reinforced vehicle during a collision. As a result, the one or more additional vehicles may be prevented from “submarining” underneath the reinforced vehicle.

One particular type of reinforcement structure configured as a barrier may be a rear intrusion guard (RIG). RIG may be configured to prevent unwanted submarining of vehicles during a collision with the rear of a vehicle. In particular, it is envisioned that RIGs may be well adapted for protecting a rear of a trailer for a transportation vehicle, such as a semitruck or other shipping container adapted for a vehicle. As such, the RIG may be positioned along or near a rear face of the trailer of the vehicle. For example, the rear face of the trailer may be considered a rearmost facing surface of the trailer, such as a rear access point of the trailer having one or more trailer doors. However, it should be noted that any transportation vehicles may utilize an RIG as described herein. Similarly, while reference may be made to RIGs specifically by way of example, the present teachings are directed to any type of barrier or intrusion guard of a vehicle. That is, the present teachings may provide a side or front intrusion guard as well as the RIG described herein.

As discussed in further detail below, conventional intrusion guards may often utilize a thick steel member having one or more attachment points that are welded directly to a vehicle or a trailer thereof. As a result, the intrusion guard may have a significant weight impact on the vehicle, may require substantial time and/or cost for installation due to the number of weld points, may have a greater cost impact due to the materials utilized, or a combination thereof. Even further, conventional intrusion guards may often be adapted for protecting intrusion as discussed above, but are often not able to protect a vehicle having the intrusion guard from impact damage. That is, when a conventional intrusion guard is impacted, the instruction guard may be deformed or otherwise damaged and, as a result, a rear portion of the vehicle or a trailer of the vehicle may also be damaged. Therefore, after such an impact, both the intrusion guard and one or more portions of the vehicle or trailer of the vehicle may require repair, replacement, or both.

However, the teachings herein envision an alternative solution to comply with current performance requirements yet provide an improved structure and material selection. The intrusion guard as described herein may advantageously prevent unwanted intrusion such as those identified above while also absorbing and/or deflect impacts for outside sources. When compared to a conventional intrusion guard, the teachings herein may provide an improved intrusion guard that may either withstand an outside impact or may otherwise absorb and/or deflect the impact so that the vehicle and/or trailer of the vehicle may remain intact. That is, the intrusion guard may be easily replaced after damage from impact without a need to repair and/or replace any further parts of the vehicle or trailer thereof, thereby providing a much more robust guard.

The intrusion guard may be substantially lighter than conventional intrusion guards. The intrusion guard as described herein may be about 10% lighter or more, about 30% lighter or more, or about 50% lighter or more than conventional guards. The intrusion guard may be about 90% lighter or less, about 75% lighter or less, or about 60% lighter or less. The intrusion guard may weigh about 20 kilograms or more, about 40 kilograms or more, or about 60 kilograms or more. The reinforcement structure may weigh about 100 kilograms or less, about 80 kilograms or less, or about 70 kilograms or less.

The intrusion guard may include one or more reinforcing members. The reinforcing member may function to reinforce the intrusion guard. The reinforcing member may function to absorb all or a portion of an impact during a collision. The reinforcing member may provide a connection point between the intrusion guard and the trailer of a vehicle, either directly or indirectly.

The reinforcing member may include a shell. The shell may function to encase one or more additional layers or portions of the reinforcing member, such as a support and/or insert of the reinforcing member. The shell may function to contact the one or more additional vehicles during a collision. The shell may be a single monolithically formed (i.e., integrally formed) structure. The shell may have a plurality of pieces. For example, the shell may be a clamshell having opposing portions secured to one another. The shell may be fully or partially enclosed. For example, the shell may be enclosed a full 360 degrees around a longitudinal axis of the shell and have openings at opposing ends of the shell. The shell may be partially enclosed. The shell may be enclosed about 180 degrees or more, about 225 degrees or more, or about 270 degrees or more. The shell may be enclosed about 360 degrees or less, about 305 degrees or less, or about 275 degrees or less. The shell may be hollow. The shell may contain one or more cavities. The shell may be any desired size and shape. As such, the shell may be adapted to cover one or more surfaces of an internal

The shell may have one or more surfaces. The surfaces may include one or more projections, one or more arcuate portions, one or more planar portions, one or more curves, one or more bends, one or more steps, one or more undulations, one or more bumps, one or more grooves, one or more flanges, or a combination thereof. The shell may include one or more attachment means to secure the reinforcement structure to a vehicle. The shell may be free of attachment means. The shell may include one or more holes, one or more cutouts, or both. The shell may include one or more faces.

The shell may be structurally rigid. The shell may be flexible. The shell may have one or more localized flexible joints that allow flexing of the shell only at desired locations. The shell may be compressible. The shell may be elastic so that, upon flexing, the shell may return to an original position free of inelastic deformation. The shell may be structurally rigid to support a desired load. For example, the shell may support about 25 kilograms or more, about 50 kilograms or more, or about 75 kilograms or more. The shell may support about 175 kilograms or less, about 150 kilograms or less, or about 125 kilograms or less.

The shell may provide a protective layer to the reinforcing member. That is, the shell may provide moisture protection, corrosion protection, impact protection, or a combination thereof to the reinforcing member at least partially housed within the shell. As such, the shell may be locally disposed over portions of the reinforcing member in specific locations.

The reinforcing member may include a support. The support of the reinforcing member may substantially form a shape of the reinforcing member. The support may function to absorb all or a portion of an impact during a collision. The support may be shaped similar to the shell or may be different. The support may be a solid member or may be substantially hollow. The support may include one or more faces, one or more planar portions, one or more arcuate portions, or a combination thereof.

The support may be at least partially secured within the shell. The support may be secured within the shell via one or more fasteners, one or more adhesives, or both. If an adhesive is utilized, it is envisioned that the adhesive may be a thermosetting or a thermoactivatable adhesive material. For example, the adhesive may be coextruded or overmolded to the support to provide an attachment means for the shell.

Alternatively, or additionally, one or more additional adhesives may be utilized. The adhesive may be an injectable or pumpable adhesive. The adhesive may be an activatable material. Activation may be done using a stimulus, such as exposure to a heightened temperature, activating agent, or both. However, it is also envisioned that a room-temperature cured adhesive may also be utilized to advantageously remove any need for an activating agent or secondary operation to cure the adhesive during assembly. For example, the adhesive may be injected into one or more portions of the support, the shell, or both, and/or may be pumped onto one or more portions of the support, the shell, or both. Upon distribution of the adhesive onto the support and/or the shell, the adhesive may cure at room temperature to secure the shell to the support, or vice versa.

The adhesive may be flame retardant. The adhesive may be expandable, foamable, or both. The adhesive may be a one-component or two-component composition. The adhesive may include at least one epoxy resin. The adhesive may include at least one esterified reaction product formed by reacting a phosphoric acid and an epoxide. The adhesive may include a blowing agent. The adhesive may include one or more components as a liquid, a powder, in pellet form, or a combination thereof. The adhesive may include one or more inorganic compounds, one or more organic compounds, or both. The adhesive may be free of a curing agent.

Examples of such adhesives can be found in U.S. Pat. No. 10,550,220 and U.S. application Ser. No. 16/748,305, both of which are incorporated herein in their entirety for all purposes.

Alternatively, the support may be secured within the shell free of one or more fasteners, one or more adhesive layers disposed between the shell and the support, or both. The support may create a press-fit condition with the shell. For example, a shape of the support may be substantially similar to a shape of an inner cavity of the shell so that the support abuts one or more interior walls of the shell and the one or more interior walls compressibly engages outer surfaces of the support.

The support may be formed using one or more materials. The support may be formed of a moldable material. The support may be an extruded material. The support may be a pultruded material. The support may be an injection-molded material. The support may be a composite material. The support may include one or more adhesive components. The supporter may be a polymeric material, a polyamide material, or both. The polymeric material may be a reinforced polymeric material. For example, the polymeric material may be a glass fiber reinforced polyamide. The polymeric material may be a thermoset material. The polymeric material may be a thermoplastic material. The polymeric material may be a thermoplastic epoxy material. The polymeric material may be a fiber reinforced thermoplastic epoxy material. The support may be any material that may provide structural reinforcement to a vehicle structure, one or more vehicle components, or both. The support and the shell may have similar or dissimilar compositions.

The support may be formed via one or more ribs. The walls may establish a shape of the support. The ribs may define an outer dimension of the support. The ribs may interconnect to form a shape of the support. For example, ribs may connect to one another to form a substantially outer perimeter of the support, create one or more surfaces of the support, or both. The ribs may be an exterior surface of the support. The ribs may vary in size and shape. The ribs may have a uniform thickness. The ribs may have one or more arcuate portions, one or more linear segments, or both. The ribs may be integrally formed (i.e., monolithically formed as a single piece free of secondary adhesives or fasteners that connect the ribs).

The ribs may function to increase structural integrity of the reinforcing member. The ribs may deflect, displace, or both an impact of the support, the shell, or both. The ribs may be dispersed throughout the support to provide increased structural integrity in one or more desired locations. The ribs may be a gusset, flange, or both.

The ribs may interconnect to form one or more openings of the support. The openings may function to decrease weight of the support. The openings may function to form deflection zones of the reinforcing member. The openings may function to at least partially house an insert located within the support. The openings may extend through a thickness of the support. The openings may extend through an entire thickness of the support, a partial thickness of the support, or both. The openings may vary in size and shape and may be any size and/or shape. The openings may be formed from about two or more, about three or more, or about four or more ribs. The openings may be formed from about seven or less, about six or less, or about five or less ribs. The openings may receive one or more structural components, vehicle components, additional structural member components, or a combination thereof. A plurality of openings may be located within the inner member. One or more of the openings may also include a cutout to expose an insert located within the support.

The insert may function to reinforce the support of the reinforcing member. The insert may provide additional structural integrity to the reinforcing member. The insert may be formed from a material similar to the materials described with respect to the support. However, it is envisioned that the insert may also be formed of a dissimilar yet complimentary material. That is, both the insert and the support may be formed of similar composite materials that exhibit different material properties to further tune and/or customize performance of the intrusion guard.

The insert may be at least partially enclosed by the support. The insert may be overmolded with the insert so that the insert is encased by the support. The insert may include one or more ribs, one or more openings, one or more cutouts, or a combination thereof similar to those found on the support. However, the shape of the insert may also be different to that of the insert if desired.

The insert may provide localized reinforcement to the support. The insert may strengthen the support at one or more desired locations. The insert may be positioned anywhere along the reinforcing member. The insert may be positioned between the shell and the support. The insert may be secured to one or more outer surfaces of the support (i.e., not between the shell and the support). The insert may extend along a portion of the length of the reinforcing member. The insert may extend along substantially an entire length of the reinforcing member.

The intrusion guard may include one or more brackets. The brackets may function to secure the reinforcing members to the vehicle (e.g., a trailer of the vehicle), to one or more addition components, or both. The bracket may be secured to the shell, the support, the insert, or a combination thereof. The brackets may be any size and shape. The brackets may be positioned anywhere along the intrusion guard. The brackets may be secured to the intrusion guard using one or more fasteners, one or more adhesives, one or more additional mechanical interlocks, or a combination thereof. For example, the brackets may be fastened to the reinforcing members, a trailer of a vehicle, or both. The brackets may include one or more planar portions, one or more arcuate portions, one or more bends, one or more gussets, one or more fillets, or a combination thereof. The brackets may include one or more holes for receiving one or more fasteners. The brackets may include one or more flanges to secure the brackets to the vehicle, to one or more additional components, or both. The flanges may extend at any angle and have any size and shape. The brackets may be a mounting bracket to mount the intrusion guard to a portion of vehicle, such as a sill of a vehicle trailer. Similarly, the brackets may be an attachment bracket to attach a bumper to the intrusion guard.

The bumper may function as an impact point for a vehicle during a collision. The bumper may be secured to the reinforcing members via one or more brackets such that impact to the bumper results in deformation of the reinforcing members. As such, the bumper may be replaceable due to easy installation to the reinforcing members so that damage to the bumper may be easily fixed or replaced.

The bumper may be a similar material to that of the reinforcing members or may be a dissimilar material. For example, the reinforcing members may a composite material while the bumper may be steel or may also be a composite material.

The bumper may be secured to one or more reinforcing members, two or more reinforcing member, or three or more reinforcing members. The bumper may be secured to six or less reinforcing members, five or less reinforcing members, or four or less reinforcing members. As such, it may be gleaned that the intrusion guard as described herein may include any desired number of reinforcing members.

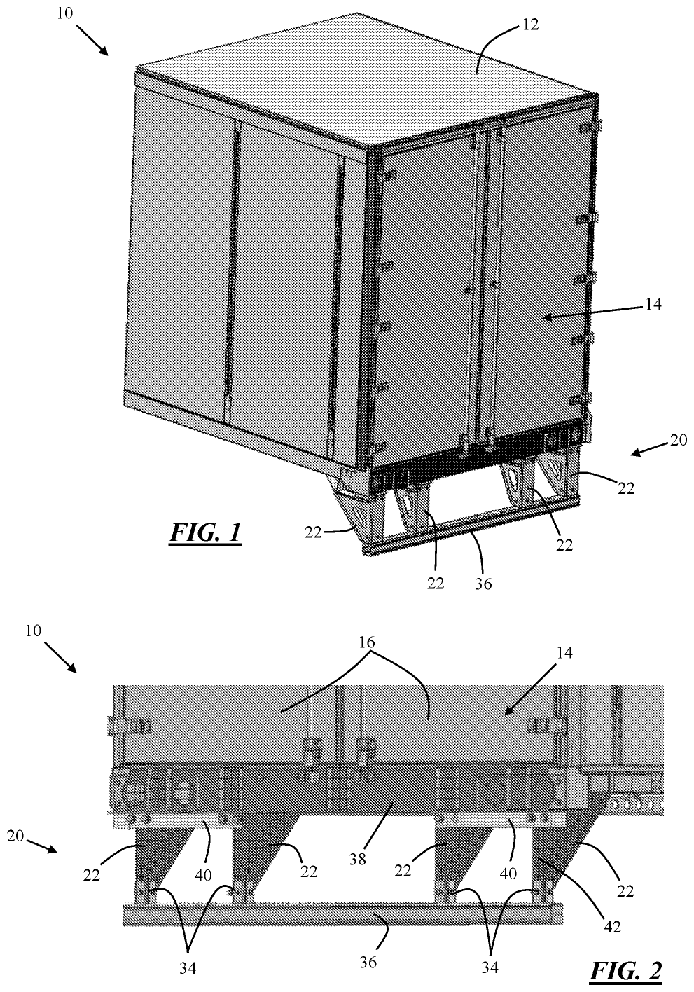

Turning now to the figures, FIG. 1 illustrates a perspective view of a trailer 12 of a vehicle 10. The trailer 12 may be attached to the vehicle 10 or integrally formed with the vehicle. For example, the vehicle 10 may be a semi-truck or other type of vehicle 10 that may be connected to a trailer 12 for transportation of goods. Similarly, the vehicle 10 may be a transport vehicle, whereby the trailer 12 is integrally formed with the vehicle 10 unlike a semi-truck. As such, it may be gleaned that the teachings herein are limited to one particular vehicle configuration.

The trailer 12 of the vehicle 10 show in FIG. 1 includes a conventional intrusion guard 20. The intrusion guard 20 may be mounted to the trailer 12 by a rear surface 14 of the trailer. The intrusion guard 20 may include a plurality of reinforcing members 22 attached to the trailer 12. The reinforcing members 22 may also secure a bumper to the trailer 12.

With respect to such a conventional intrusion guard structure 20, the reinforcing members 22 may be made entirely from metal, such as steel, and welded directly to the trailer 12. Similarly, the bumper 36 may also be welded to the reinforcing members 22, thereby creating a heavily weighted intrusion guard 20 with substantially rigid mounting means. Similarly, due to the nature of welding, repair and/or replacement of one or more portions of the intrusion guard 20 may be cumbersome, incredibly time-consuming and/or costly, or impossible without full replacement of the intrusion guard 20.

Conversely, FIG. 2 illustrates a perspective view of an intrusion guard 20 in accordance with the present teachings. As shown, the intrusion guard 20 may be positioned substantially near a rear face 14 of a trailer of a vehicle 10. Additionally, the intrusion guard 20 may be mounted along an underbody of the trailer to protect unwanted vehicles or other objects from entering clearance between the bottom of the trailer and the ground.

The intrusion guard, as shown as a rear intrusion guard of the vehicle 10, may include one or more reinforcing members 22. The reinforcing members 22 may be mounted anywhere along the trailer of the vehicle 10. For example, as shown, the reinforcing members 22 may be mounted to a sill 38 of the trailer such that vertical surfaces 42 of the reinforcing members 22 may be substantially aligned with the rear face 14 of the trailer. That is, the vertical surface 42 may be substantially coplanar and/or parallel to the rear face 14 of the trailer.

Beneficially, the reinforcing member 22 may be mounted to the sill 38 of the trailer by a mounting bracket 40. The sill 38 may be positioned near the rear face 14 of the trailer and adapted to secure one or more trailer doors 16 of the trailer. Additionally, the mounting bracket 40 may secure the reinforcing members 22 to the sill 38 using one or more fasteners. As such, the reinforcing members 22 may be more easily removed and/or replaced when compared to a conventional welded intrusion guard (e.g., FIG. 1). Similarly, such mounting features may provide for easier installation of the intrusion guard due to no longer requiring a welded connection.

The mounting brackets 40 may be shared by one or more of the reinforcing members 22, or each of the reinforcing members 22 may include their own mounting bracket 40. For example, as shown in FIG. 2, the mounting brackets 40 may each attach a pair of reinforcing members 22 to the trailer.

The reinforcing members 22 may also be secured to a bumper 36 positioned beneath the reinforcing members 22 and adapted to provide further guard to unwanted intrusion of a vehicle beneath the trailer. The reinforcing members 22 may be connected to the bumper 36 by attachment brackets 34, one or more fasteners, or both.

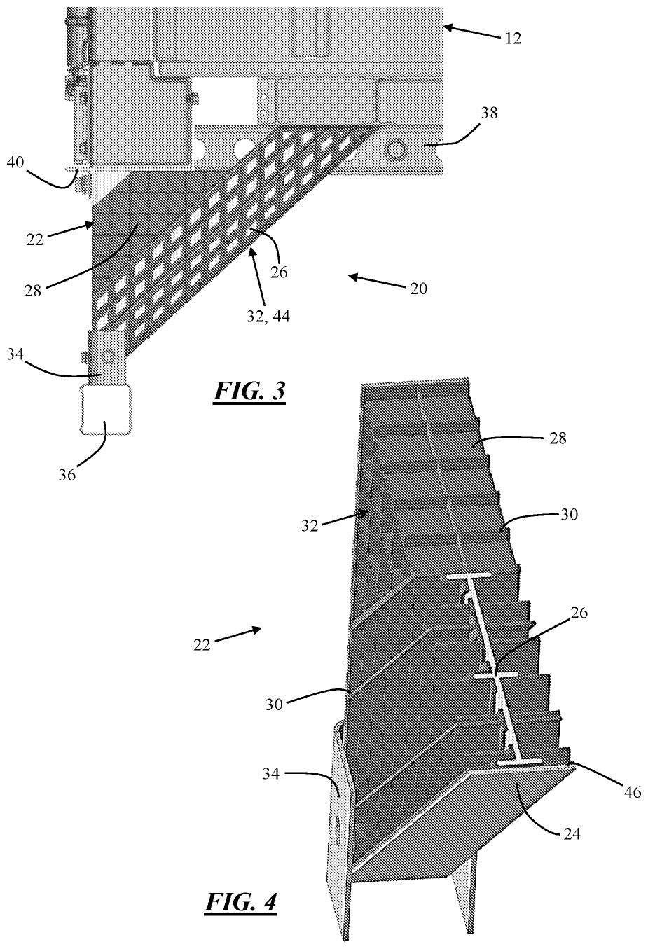

FIG. 3 illustrates a side view of the intrusion guard 20 of FIG. 2. As discussed above, the intrusion guard 20 may be secured to the sill 38 of the trailer 12 by one or more mounting brackets 40. Similarly, a bumper 36 may be attached to the reinforcing members 22 by one or more attachment brackets 34.

As shown in FIG. 3, the reinforcing member 22 may include an insert 26 positioned at least partially within a support 28. That is, the support 28 may be a structure that at least partially encompasses the insert 26, thereby providing a composite structure for the reinforcing member 22. As such, it is envisioned that the support 28 and the insert 26 may be dissimilar materials, may be similar materials having different mechanical properties, or a combination thereof. Thus, it may be gleaned from the present teachings that the composite structure of the reinforcing member 22 may provide increased tunability and customization for improved performance when compared to a conventional intrusion guard.

The insert 26 may be at least partially encompassed within the support 28 such that the insert 26 may be visible or exposed within the support 28. For example, the support 28 may include a plurality of openings 32. One or more of the openings 32 may include a cutout 44 that exposes the insert 26 positioned adjacent to the openings 32. Thus, the reinforcing member 22 may advantageously provide a composite structure having a lighter material weight without compromising structural integrity of the intrusion guard 20.

FIG. 4 illustrates a perspective view of a reinforcing member 22 of the intrusion guard in accordance with the present teachings. The reinforcing member 22 may be a composite structure having an insert 26 at least partially enclosed or surrounded by a support 28.

To ensure structural integrity of the reinforcing member 22, the support 28 and/or the insert 26 may include one or more interconnecting ribs 30. The interconnecting ribs may form a cube-like structure throughout at least a portion of the reinforcing member 22, whereby one or more interconnect openings 32 form the overall structure of the reinforcing member 22. As shown, the ribs 30 may extend transversely to one or more other ribs 30 or may extend in any desired direction or in any desired angle. However, it is envisioned that the ribs 30 extend to form one or more outer surfaces adapted to mount to the bumper, the sill of the trailer, or both via a mounting bracket (see FIG. 3) or an attachment bracket 34.

The reinforcing member 22 may advantageously also include an outer shell 24 attached to one or more outer surfaces of the support 28 and/or the insert 26. The outer shell 24 may be adhered to the outer surfaces of the support 28 and/or the insert 26 using an adhesive 46 positioned therebetween. As such, the reinforcing member 22 may provide further structural integrity while using improved composite materials.

### ILLUSTRATIVE EXAMPLES

As discussed above, the intrusion guard 20 in accordance with the present teachings may provide similar or improved structural performance when compared to a conventional steel welded or other metal rear intrusion guard. To further illustrate such surprisingly beneficial improvements, impact tests were conducted to compare performance of the intrusion guard 20 as described herein relative to a conventional 2-post and 4-post intrusion guard. The 2-post and 4-post structure may be analogous to the number of reinforcing members 22 described above (see FIGS. 1-4).

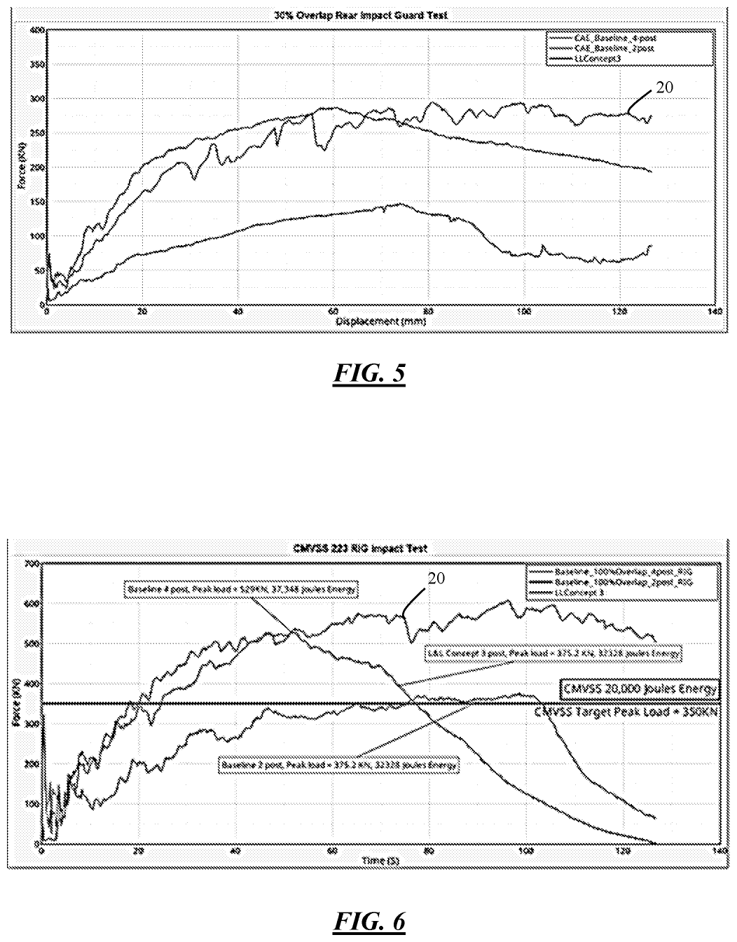

A rear intrusion guard (RIG) was tested in accordance with the Insurance Institute for Highway Safety (THIS) testing protocol for 30% overlap between an incoming midsize car and the rear of the trailer of a vehicle. The impact is conducted such that the midsize car impacts the RIG at 35 miles per hour (mph) while the trailer is parked (i.e., stationary). Test results for such testing are shown in FIG. 5.

As shown in FIG. 5, the intrusion guard 20 met or exceeded performance of a conventional 4-post intrusion guard and substantially outperformed a conventional 2-post intrusion guard. As such, the present teachings may provide for a significantly lighter weight alternative to a conventional intrusion guard without compromising overall performance during impact.

Additionally, a RIG was tested in accordance with the testing protocols outlined under Canada Motor Vehicle Safety Standards (CMVSS) 223. Test results for such testing are shown in FIG. 6. As shown in FIG. 6, the intrusion guard 20 exceeded the target threshold of a target peak load of 350 KN (kilonewtons) when compared to a 4-post and 2-post conventional rear intrusion guard.

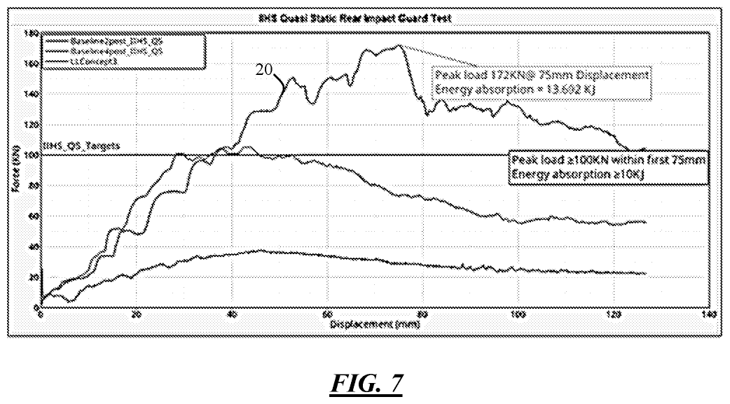

Furthermore, quasi static rear impact testing was conducted in accordance with IIHS test standards outline in their “Semitrailer Rear Impact Guard Quasi-Static Test Protocol”. As shown in FIG. 7, the intrusion guard 20 significantly exceeded the peak load threshold of 100 KN by reaching a peak load of about 172 KN-a peak significantly greater than the performance peak of both the 2-post and 4-post conventional intrusion guards.

Thus, as may be gleaned from the above illustrative examples, the intrusion guard 20 as described herein may advantageously meet or exceed the performance of conventional rear intrusion guards while providing substantial cost-savings, weight reduction, improved installation methodology, or a combination thereof.

### REFERENCE LIST

10 Vehicle
12 Trailer
14 Rear Face of the Trailer
16 Trailer Door
20 Intrusion Guard
22 Reinforcing Member
24 Outer Shell
26 Insert
28 Support
30 Rib
32 Opening
34 Attachment Bracket
36 Bumper
38 Sill
40 Mounting Bracket
42 Vertical Surface of the Reinforcing Member
44 Cutout
46 Adhesive

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference in their entirety into this written description.

1. An intrusion guard for a trailer of a vehicle, comprising:
(a) a reinforcing member adapted for connection to the trailer of the vehicle, wherein the reinforcing member includes a support and an insert positioned at least partially within the support; and
(b) a bumper connected to the reinforcing member.

2. The intrusion guard of claim 1, wherein the reinforcing member is mounted to a sill of the trailer.

3. The intrusion guard of claim 1, wherein the intrusion guard is mounted to the vehicle free of welding or other permanent attachment means that may cause damage to the intrusion guard during removal and/or replacement.

4. The intrusion guard of claim 1, wherein the bumper is free of contact with the trailer.

5. The intrusion guard of claim 2, wherein the reinforcing member is mounting to the sill by a mounting bracket.

6-7. (canceled)

8. The intrusion guard of any of claim 1, wherein the reinforcing member includes interconnecting ribs that form one or more openings along the reinforcing member.

9. The intrusion guard of claim 8, wherein the one or more openings include a cutout, and the insert is visible through the cutout.

10. The intrusion guard of claim 8, wherein the intrusion guard includes two or more reinforcing members, and preferably four or more reinforcing members.

11. The intrusion guard of any claim 8, wherein a vertical surface of the reinforcing member is parallel to a rear face of the trailer of the vehicle when the intrusion guard is mounted to the trailer and the vertical surface of the reinforcing member is coplanar with the rear face of the trailer.

12-13. (canceled)

14. The intrusion guard of claim 1, wherein the reinforcing member includes an outer shell disposed along an outer surface of the support.

15. The intrusion guard of claim 14, wherein the outer shell is steel.

16. The intrusion guard of claim 15, wherein the outer shell is adhered to the support of the reinforcing member by an adhesive that is a thermoplastic adhesive overmolded onto the reinforcing member or a room temperature cured adhesive applied to the reinforcing member.

17-18. (canceled)

19. The intrusion guard of claim 14, wherein the support is overmolded around the insert.

20. The intrusion guard of claim 14, wherein the reinforcing member meets Insurance Institute for Highway Safety (IHIS) testing protocols for 30% overlap rear impact testing, full rear impact testing, rear angled impact testing, quasi static rear impact testing, or a combination thereof.

21. The intrusion guard of claim 16, wherein the outer shell is adhered to the support of the reinforcing member using a room-temperature cured adhesive that is injected onto the outer shell, the support of the reinforcing member, or both.

22. The intrusion guard of claim 16, wherein the adhesive is free of a curing agent.

23. The intrusion guard of claim 16, wherein the adhesive is flame retardant.

24. The intrusion guard of claim 16, wherein the adhesive is foamable, expandable, or both.

25. The intrusion guard of claim 16, wherein the room-temperature cured adhesive includes at least one epoxy resin, at least one esterified reaction product formed by reacting a phosphoric acid and an epoxide, a blowing agent, or a combination thereof.

26. The intrusion guard of claim 1, wherein the intrusion guard is adapted to protect a rear portion of the trailer of the vehicle so that, when the intrusion guard sustains an impact, the rear portion of the trailer remains intact, and the intrusion guard is replaced.
